(19) United States
(12) Patent Application Publication
(10) Pub. No.: US 2018/0161872 A1
(43) Pub. Date: Jun. 14, 2018

(54) METHOD FOR PRODUCING A TURBINE BLADE BY MEANS OF ELECTRON BEAM MELTING

(71) Applicant: Siemens Aktiengesellschaft, Munich (DE)

(72) Inventor: Christian Brunhuber, Auerbach (DE)

(73) Assignee: Siemens Aktiengesellschaft, Munich (DE)

(21) Appl. No.: 15/578,896

(22) PCT Filed: Apr. 27, 2016
(86) PCT No.: PCT/EP2016/059412

§ 371 Date: Dec. 1, 2017

(30) Foreign Application Priority Data
Jun. 12, 2015 (DE) 102015210744.2

(51) Int. Cl. B22F 3/105; B22F 5/00; B22F 5/04; B22F 7/06; F01D 5/14; F01D 5/30

(52) U.S. Cl. CPC B22F 3/1055; B22F 5/009; B22F 5/04; B22F 7/06; F05D 2300/175; F01D 5/30; F05D 2230/234; F05D 2230/31; F01D 5/14

(57) ABSTRACT

A method for producing a turbine blade with a blade root portion, a blade aerofoil portion, adjoining the blade root portion, and a blade tip portion, adjoining the blade aerofoil portion, wherein the blade root portion, the blade aerofoil portion and the blade tip portion are connected to one another in a material-bonding manner, and wherein at least one cavity, serving as a cooling channel, extends through the blade root portion and the blade aerofoil portion, wherein at least the blade aerofoil portion is produced layer by layer by using an EBM process, and, after removing caked-on powder material from the at least one cavity, the blade tip portion is produced by using some other production technology.

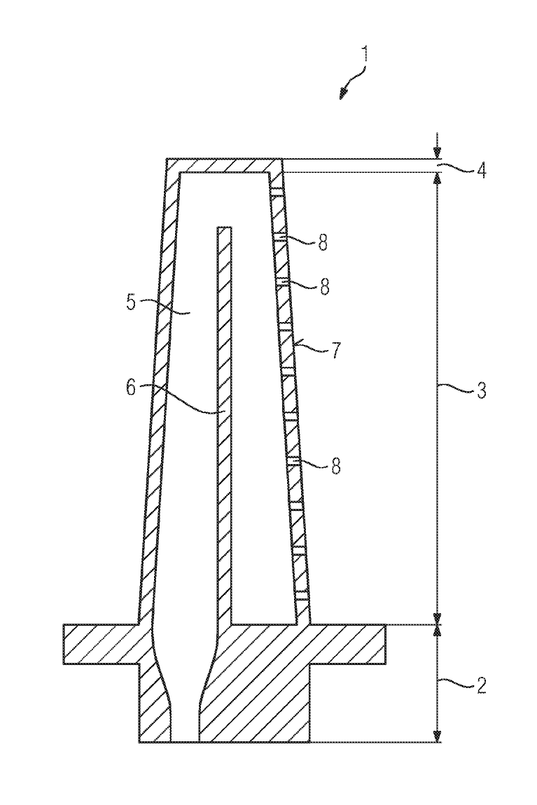

### CROSS REFERENCE TO RELATED APPLICATIONS

This application is the US National Stage of International Application No. PCT/EP2016/059412 filed Apr. 27, 2016, and claims the benefit thereof. The International Application claims the benefit of German Application No. DE 102015210744.2 filed Jun. 12, 2015. All of the applications are incorporated by reference herein in their entirety.

### FIELD OF INVENTION

The present invention relates to a method for producing a turbine blade having a blade root section, a blade airfoil section adjoining the blade root section, and a blade tip section adjoining the blade airfoil section, wherein the blade root section, the blade airfoil section and the blade tip section are connected to one another in a materially bonded manner, and wherein at least one cavity, serving as a cooling channel, extends through the blade root section and the blade airfoil section.

### BACKGROUND OF INVENTION

Turbine blades of the type mentioned at the beginning, which have a blade root section, a blade airfoil section and a blade tip section, are known in a wide variety of configurations in the prior art and are installed for example in gas turbines as rotor blades, where they convert the flow energy of expanding hot gases into rotational energy.

During the operation of a gas turbine, the turbine blades are subjected to high thermal and mechanical loading due to the high temperatures of the hot gas and the high rotational speed of the turbine shaft. On the one hand, solidly formed rotor blades offer high mechanical load-bearing capacity. On the other hand, however, they limit the maximum permissible temperature of the hot gas flowing through and thus the efficiency of the gas turbine. In order to increase the thermal load-bearing capacity, the blade root section and the blade airfoil section are therefore often provided with cavities forming cooling channels, which extend in the radial direction and are flowed through by a cooling fluid during the intended operation of the gas turbine. The cooling fluid heated in the turbine blade then exits the turbine blade via corresponding cooling fluid outlet openings and flows, together with the expanded hot gas, through an exhaust-gas channel out of the gas turbine.

Solidly formed turbine blades are not subject to practical limitations with regard to their production since they are able to be produced solely by cutting external machining of a blank. By contrast, cooled turbine blades are usually produced by means of casting because of their complex forms due to the cavities. For this purpose, at least one core for creating the at least one cavity is introduced into a casting mold defining the external surface of the turbine blade. Said core is aligned by positioning means in the casting mold in order to set the required wall thickness of the turbine blade. The intermediate space remaining between the casting mold and the core is then filled with heated, liquid cast material. After the solidification of the cast material, the core can then be chemically removed, for example using a suitable solvent, in order in this way to expose the cavity.

Prototypes of turbine blades with newly developed designs are firstly produced, which are then tested in a gas turbine. Additive production methods are being used increasingly often in the production of such prototypes since said methods offer the possibility of building up turbine blades in layers, proceeding from a CAD drawing, within a very short time interval. One additive production method which in principle is promising is the LMD (laser metal deposition) method, in which a metallic material in powder form is fed to a carrier gas stream and melted by a laser beam on the way to the deposition position. A significant advantage of the LMD method is that even very complex forms, provided with cavities and undercuts, can be produced. By contrast, metallic materials with a very high γ′ content, such as for example nickel-based alloys, from which thermally highly stressed turbine blades are often produced, cannot be processed or can be processed only very poorly.

An alternative is the EBM (electron beam melting) method. This is a method in which metallic components are generated layer by layer from a powder bed in that regions of the powder bed are melted using an electron beam and correspondingly solidified. Owing to the high process temperatures, even metallic materials with a high γ′ content can be processed. During the carrying out of the method, it is to be ensured, however, that the powder bed bakes on even in regions in which no component layer is generated in order to prevent the so-called “smoke effect” due to electrical charging of the powder, which smoke effect leads to powder of the powder bed being distributed in the entire installation space in an uncontrolled manner. Correspondingly, the baked-on powder has to be removed subsequently using a suitable tool. However, for this purpose, the baked-on powder has to be accessible. This accessibility is in principle not realized in the case of internal cavities, such as for example in the case of cavities, defining cooling channels, of turbine blades of the type mentioned at the beginning. Against this background, the EBM method is currently used solely for the production of prototypes of solidly formed turbine blades.

### SUMMARY OF INVENTION

Proceeding from said prior art, it is an object of the present invention to provide an alternative method for producing a turbine blade of the type mentioned at the beginning.

In order to achieve said object, the present invention provides a method for producing a turbine blade of the type mentioned at the beginning, which method is characterized in that at least the blade airfoil section is produced in layers using an EBM method, and in that the blade tip section is produced using some other production technology after baked-on powder material is removed from the at least one cavity. Owing to the fact that, in the method according to the invention, the blade airfoil section is firstly generated using an EBM method without the blade tip section, at least one cavity, which is defined by the blade airfoil section, remains open at least on the upper side and thus accessible for the purpose of removing baked-on powder material. Correspondingly, using the method according to the invention, the blade airfoil section may be produced from almost any desired metallic materials, or by means of alloys, in a quick and low-cost manner, this being a major advantage in particular in the production of prototypes. The blade airfoil section may thus be produced for example from a superalloy, for example from a nickel-based superalloy.

According to one variant of the present invention, the blade root section and the blade airfoil section are, together, produced in layers using an EBM method. This variant is characterized in that a large part of the turbine blade can be generated more or less directly from a CAD drawing.

According to another variant of the method according to the invention, the blade root section is provided as a prefabricated component, wherein the blade airfoil section is built up in layers on the blade root section using an EBM method, or wherein the blade airfoil section is produced in layers in advance using an EBM method and subsequently connected in a materially bonded manner, in particular welded, to the blade root section.

If the blade root section is a prefabricated component, then this is advantageously produced by casting. Alternatively, however, a still intact blade root section of a turbine blade which has been taken out of service may also be used.

According to one configuration of the present invention, the blade airfoil section and the blade root section are produced from a first material, and the blade tip section is produced from a second material which is different from the first material, wherein the second material is in particular a material which has better oxidation resistance than the first material. This material selection is an advantage to the extent that it is appropriate for the actual stresses of a turbine blade. While the blade root section and the blade airfoil section are usually subjected to very high mechanical stresses during the intended use of a turbine blade owing to the dynamic forces, this is not so much the case with the blade tip section. In the case of the blade tip section, the emphasis is rather on high oxidation resistance. The blade tip section may thus be produced for example from IN738LC.

The blade root section and the blade airfoil section are advantageously produced from a superalloy, in particular from a nickel-based alloy. Superalloys, and in particular nickel-based alloys, have proven successful in the past as materials in particular for gas turbine blades.

According to one configuration of the method according to the invention, after the production of the blade airfoil section, the blade tip section is connected as a prefabricated component to the blade airfoil in a materially bonded manner or built up in layers on the free end of the blade airfoil section using an additive production method, in particular using an LMD method. The LMD method is an advantage for the production of the blade tip section to the extent that, using the LMD method, the material can be applied directly on the blade airfoil section without the formation of a powder bed being required.

### BRIEF DESCRIPTION OF THE DRAWINGS

Further features and advantages of the present invention will become clear on the basis of the following description with reference to the drawing, which schematically shows a cross-sectional view of a turbine blade which has been produced using a method as per an embodiment of the present invention.

### DETAILED DESCRIPTION OF INVENTION

The turbine blade 1 comprises a blade root section 2, a blade airfoil section 3 adjoining the blade root section 2, and a blade tip section 4 adjoining the blade airfoil section 3, wherein the blade root section 2, the blade airfoil section 3 and the blade tip section 4 are connected to one another in a materially bonded manner. A cavity 5, serving as a cooling channel, extends radially through the blade root section 2 and the blade airfoil section 3. In the present case, the cavity 5 is subdivided by a partition 6, which extends from the blade root section 2 radially outwardly in the direction of the blade tip section 4, whereby the cavity 5 is of substantially U-shaped form overall. However, it should be clear that the form and the position of the partition 6, just like the partition 6 itself, are optional. Also, it goes without saying that multiple partitions 6 may be provided, which subdivide the cavity 5 in some other way. Formed on a downstream edge 7 of the blade airfoil section 3 are cooling fluid outlet openings 8 which are in communication with the cavity 5. In the present case, the turbine blade 1 is a rotor blade of a gas turbine. In principle, however, the turbine blade 1 may also be used in other turbines.

In order to produce the turbine blade 1, in a first step, the blade root section 2 and the blade airfoil section 3 are, together, produced in layers from a superalloy, in the present case from a nickel-based superalloy, using an EBM method. In this case, the blade root section 2, and subsequently the blade airfoil section 3, are generated layer by layer from a powder bed comprising superalloy particles, in that regions of the powder bed are melted using an electron beam in a known manner and correspondingly solidified. Here, the powder bed is baked on even in regions in which no component layer is generated, in order in this way to prevent the “smoke effect” already described at the beginning. After completion of the blade root section 2 and the blade airfoil section 3, the baked-on regions of the powder bed are detached and removed in the region of the cavity 5 using suitable tools. The cavity 5 is in this case accessible both from the lower end of the blade root section 2 and from the upper end of the blade airfoil section 3. The cooling fluid outlet openings 8 may be produced already during the additive production of the blade airfoil section 3. Alternatively, however, they may also be introduced subsequently, for example by means of drilling or the like.

The blade root section 2 may alternatively be provided already as a prefabricated component. Thus, the blade root section 2 may be provided for example as a cast part. However, it is equally also possible to use a still intact blade root section of a turbine blade which has been taken out of service. If a prefabricated component is used for the blade root section 2, then the blade airfoil section 3 may be built up in layers on the blade root section 2 using an EBM method. However, it is equally also possible for the blade airfoil section 3 to be produced in layers in advance using an EBM method and subsequently connected in a materially bonded manner, in particular welded, to the blade root section 2.

After the baked-on powder material has been removed from the cavity 5, in a further step, the blade tip section 4 is produced using some other production technology. For this purpose, use is made of a material which differs from the material of the blade root section 2 and the blade airfoil section 3. The material of the blade tip section 4 is in particular a material which has better oxidation resistance than the material of the blade root section 2 and of the blade airfoil section 3. In particular, IN738LC is used as material of the blade tip section 4.

In the present case, the blade tip section 4 is built up in layers on the free end of the blade airfoil section 3 using an LMD method. It should be clear, however, that an alternative additive production method may in principle also be used, as long as, in this case, it is not a powder-bed-based method. Alternatively, it is also possible for the blade tip section 4 to be connected in a materially bonded manner, in particular welded, as a prefabricated component, for example in the form of a cast part, to the blade airfoil 3.

A significant advantage of the method according to the invention is that turbine blades whose blade root section and blade airfoil sections are composed of materials with a high γ′ content, in particular of superalloys, can be produced in very short time intervals in a simple and low-cost manner, this being an advantage in particular for the production of prototypes.

Although the invention has been illustrated and described in more detail by way of the preferred exemplary embodiment, the invention is not limited by the examples disclosed, and other variations can be derived therefrom by a person skilled in the art without departing from the scope of protection of the invention.

1. A method for producing a turbine blade having a blade root section, a blade airfoil section adjoining the blade root section, and a blade tip section adjoining the blade airfoil section,
wherein the blade root section, the blade airfoil section and the blade tip section are connected to one another in a materially bonded manner, and
wherein at least one cavity, serving as a cooling channel, extends through the blade root section and the blade airfoil section,
the method comprising:
producing at least the blade airfoil section in layers using an EBM method, and
producing the blade tip section using some other production technology after baked-on powder material is removed from the at least one cavity.

2. The method as claimed in claim 1,
wherein the blade root section and the blade airfoil section are, together, produced in layers using an EBM method.

3. The method as claimed in claim 1,
wherein the blade root section is provided as a prefabricated component,
wherein the blade airfoil section is built up in layers on the blade root section using an EBM method, or
wherein the blade airfoil section is produced in layers in advance using an EBM method and
subsequently connected in a materially bonded manner.

4. The method as claimed in claim 3,
wherein the blade root section is produced by casting.

5. The method as claimed in claim 1,
wherein the blade root section and the blade airfoil section are produced from a first material, and
wherein the blade tip section is produced from a second material which is different from the first material.

6. The method as claimed in claim 1,
wherein the blade root section and the blade airfoil section are produced from a superalloy.

7. The method as claimed in claim 1,
wherein after the production of the blade airfoil section, the blade tip section is connected as a prefabricated component to the blade airfoil section in a materially bonded manner or
built up in layers on the free end of the blade airfoil section using an additive production method.

8. The method as claimed in claim 3,
wherein the blade airfoil section is produced in layers in advance using an EBM method and subsequently connected in a materially bonded manner by welding to the blade root section.

9. The method as claimed in claim 5,
wherein the second material is a material which has better oxidation resistance than the first material.

10. The method as claimed in claim 6,
wherein the blade root section and the blade airfoil section are produced from a superalloy comprising a nickel-based alloy.

11. The method as claimed in claim 7,
wherein the additive production method comprises an LMD method.
